(19) United States
(12) Patent Application Publication
(10) Pub. No.: US 2011/0181255 A1
(43) Pub. Date: Jul. 28, 2011

(54) SEMICONDUCTOR DEVICE AND POWER SUPPLY UNIT USING THE SAME

(75) Inventors: Takayuki HASHIMOTO, Tokai (JP); Tetsuya KAWASHIMA, Tokai (JP)

(73) Assignee: RENESAS ELECTRONICS CORPORATION, Kanagawa (JP)

(21) Appl. No.: 13/005,206

(22) Filed: Jan. 12, 2011

(30) Foreign Application Priority Data
Jan. 25, 2010 (JP) 2010-012915

(51) Int. Cl. G05F 1/00

(52) U.S. Cl. 323/272

(57) ABSTRACT

In a power supply unit having high-side and low-side switching elements each including power MOSFETs connected in parallel, the power MOSFETs are controlled so that the number of the transistors in an off state is increased as an output current becomes lower, and particularly, the transistors turned off when the output current is low are disposed on an outer side of a loop formed from a positive terminal of an input capacitor of a printed board to a negative terminal of the input capacitor via the switching elements. Thus, by turning off packages of the power MOSFETs disposed on an outer side of the main circuit loop and turning on packages of the power MOSFETs disposed on an inner side of the loop, the parasitic inductance of a main circuit is reduced, so that the switching loss can be reduced and efficiency in a light load can be improved.

### CROSS-REFERENCE TO RELATED APPLICATION

The present application claims priority from Japanese Patent Application No. 2010-12915 filed on Jan. 25, 2010, the content of which is hereby incorporated by reference into this application.

### TECHNICAL FIELD OF THE INVENTION

The present invention relates to a technology for a semiconductor device, and more particularly to a technology effectively applied to a semiconductor device including a synchronous rectifier circuit used in an electronic device or the like and a power supply unit using the same.

### BACKGROUND OF THE INVENTION

The power supply unit shown in FIG. 12 is known as a power supply unit conventionally used in an electronic device or the like. In the power supply unit shown in FIG. 12, the DC power input from a DC input power supply 60 to an input section 51 including an input capacitor 61 is switched in a switching section 52 including an active element 62 based on a control signal output from a driving section 70 of a control section 54, and the power is supplied to a load 66 from an output section 53 including a commutating diode 63 and an output filter 55. The voltage and current output to the load 66 are detected in a detecting section 67, a detection value thereof and a control target value of the load 66 set in a setting section 68 are compared in a comparison operation section 69, and a control signal based on the comparison result is output from the driving section 70 to the switching section 52. In this manner, the power supplied to the load 66 is controlled so as to coincide with the control target value.

FIG. 13 shows the specific circuit configuration of the power supply unit described above. As shown in FIG. 13, the switching section 52 is made up of an active element (for example, transistor, MOSFET or others) 62. The output section 53 is made up of the commutating diode 63 and the output filter including a choke coil 64 and an output capacitor 65. The control section 54 is made up of the comparison operation section 69, the setting section 68 and the driving section 70. Furthermore, the control section 54 has an oscillating circuit (not shown) and outputs a pulse signal from the driving section 70 to the active element 62. By this means, the DC voltage Vin from the DC input power supply 60 applied to the active element 62 is switched.

When the active element 62 is in an on state, the DC power is charged in the choke coil 64 and the output capacitor 65 and is supplied to the load 66. When the active element 62 is in an off state, the energy charged in the choke coil 64 and the output capacitor 65 is supplied to the load 66 via the commutating diode 63.

At this time, in the control section 54, the comparison operation section 69 monitors the output voltage Vo detected by the detecting section 67 and compares the output voltage Vo with the control target value set in the setting section 68, and the control signal based on the comparison result is output to the switching section 52 from the driving section 70. By this means, the on/off control of the active element 62 is performed, and the power supplied to the load 66 is controlled so as to coincide with the control target value. The output voltage Vo at this time is expressed by the following expression (1).

Vo=Vinx (Ton/T) . . . (1)

Here, Vin denotes the DC voltage from the DC input power supply 60, T denotes the period of the pulse signal output from the driving section 70, and Ton denotes a conduction time of the active element 62 in the period T. More specifically, Ton/T denotes the duty ratio.

Incidentally, the commutating diode 63 which is a passive element is usually used for the commutation side of the output section 53 as shown in FIG. 13, but the commutating diode 63 has the current-voltage characteristics as shown in FIG. 14, and the forward voltage is saturated when the current reaches a predetermined value or more. The saturation voltage is 0.9 V to 1.3 V in a fast diode and is 0.45 V to 0.55 V in a Schottky diode. As described above, there has been a problem of the deterioration of the power conversion efficiency due to the power loss caused by the saturation of the forward voltage of the commutating diode 63. Furthermore, since the junction temperature of the element increases due to the high power loss, there has been a problem that the junction temperature has to be suppressed by connecting many (two, three or others) commutating diodes 63 in parallel so as to distribute the power loss per one element as the output current becomes higher.

For the solution of these problems, the power supply unit of the synchronous rectification type in which a power MOSFET 3 (built-in diode 3A) is used on the commutation side as shown in FIG. 15 has been conventionally known. This utilizes the facts that the current-voltage characteristics of the MOSFET becomes linear depending on the gate voltage unlike the non-linear current-voltage characteristics of the diode and the voltage drop of the MOSFET is smaller than that of the diode as shown in FIG. 16.

The power supply unit shown in FIG. 15 is provided with a power MOSFET 2 for switching (built-in diode 2A), and a control signal is input from a control circuit 8 to a gate terminal of the power MOSFET 2. When the power MOSFET 2 is in a conduction state, the input power is charged in an output capacitor 5 and supplied to a load 6 through a choke coil 4. Next, when the power MOSFET 2 is brought into a non-conduction state, magnetic energy stored in the choke coil 4 is discharged, and the commutation current flows in a detection resistor 7 and the built-in diode 3A of the power MOSFET 3 via the output capacitor 5 and the load 6. At this time, a voltage drop is caused by the detection resistor 7, and this voltage drop taken as a detection voltage is compared with a reference voltage Vref output from a reference voltage power supply 82 by a comparator 80. Then, when the detection voltage is higher than the reference voltage Vref, the comparator 80 outputs a high level to render the power MOSFET 3 conductive via a driving circuit 81.

The conversion efficiency (output voltage/input voltage) η of this power supply unit is gradually lowered with the increase of the output current Io as shown in FIG. 17. This is because the power loss PFET of the power MOSFET expressed by the following expression (2) increases in proportion to the square of the drain current ID under the constant on-resistance Ron.

PFET=RonxID²=(RonxID)×ID . . . (2)

For the solution of this problem, Japanese utility model application publication No. 6-44396 (Patent Document 1) suggests a technology of halving the on-resistance by connecting the power MOSFETs in parallel.

However, since two power MOSFETs are always driven simultaneously in such a power supply unit, the required driving power is doubled, and although it is possible to improve the efficiency in the heavy load (=region in which output current Io is high), the loss in the light load (=region in which output current Io is low) is relatively increased and the efficiency is lowered.

For the solution of this problem, Japanese Patent Application Laid-Open Publication No. 2006-211760 (Patent Document 2) suggests a technology of controlling the number of power MOSFETs to be turned on out of the power MOSFETs connected in parallel depending on the output current. In this technology, at least one power MOSFET is selected and driven depending on the output current. For example, in the case where a plurality of switching elements all have the same characteristics, that is, the magnitude of the current to be delivered is the same, one switching element is driven when the output current is low, that is, in the light load, and the number of switching elements to be driven is increased as the output current becomes higher, that is, the load becomes heavier. The unnecessary waste of the driving power can be prevented by driving only one switching element in the light load, and the conduction loss of the switching elements can be reduced by driving a plurality of switching elements in the heavy load. Therefore, the power supply efficiency can be improved over the heavy load from the light load.

### SUMMARY OF THE INVENTION

However, the Patent Document 2 does not describe the method of mounting the power MOSFETs. As a major loss in the case of the light load, there is a switching loss caused by the output capacitance Coss between a drain and a source other than the drive loss generated in driving the power MOSFETs. In the case of the light load, the drive loss can be reduced by turning off at least one or more gates of the power MOSFETs connected in parallel, but the switching loss cannot be reduced.

Therefore, an object of the present invention is to provide a technology capable of reducing not only the drive loss but also the switching loss for the solution of the problems of the above-described conventional technologies.

The above and other objects and novel characteristics of the present invention will be apparent from the description of the present specification and the accompanying drawings.

The following is a brief description of an outline of the typical invention disclosed in the present application.

In an outline of the typical invention, first and second switching elements connected in series between a voltage input terminal and a reference potential terminal are made up of a plurality of transistors (for example, power MOSFETs) connected in parallel, and the plurality of transistors connected in parallel are controlled so that the number of the transistors in an off state is increased as the output current becomes lower, and in particular, the transistors to be turned off when the output current is low are disposed on an outer side of a loop formed from a positive terminal of an input capacitor of a printed board to a negative terminal of the input capacitor via the first and second switching elements.

The effects obtained by typical embodiments of the invention disclosed in the present application will be briefly described below.

As the effects obtained by the typical embodiments, not only the reduction in the drive loss of the transistors but also the reduction in switching loss can be achieved.

### BRIEF DESCRIPTIONS OF THE DRAWINGS

FIG. 1 is a diagram showing a circuit of a power supply unit in a first embodiment of the present invention;

FIG. 2A is a drawing showing mounting and control of the power supply unit corresponding to the circuit diagram of FIG. 1 in the case of a normal load in the first embodiment of the present invention;

FIG. 2B is a drawing showing mounting and control of the power supply unit corresponding to the circuit diagram of FIG. 1 in the case of a light load in the first embodiment of the present invention;

FIG. 3 is a diagram showing the effects of the power supply unit in the first embodiment of the present invention;

FIG. 4A is a drawing showing mounting and control of the power supply unit in the case of a normal load in the second embodiment of the present invention;

FIG. 4B is a drawing showing mounting and control of the power supply unit in the case of a light load in the second embodiment of the present invention;

FIG. 5A is a drawing showing details of the external appearance of the package shown in FIGS. 4A and 4B in the second embodiment of the present invention;

FIG. 5B is a drawing showing details of the interior of the package shown in FIGS. 4A and 4B in the second embodiment of the present invention;

FIG. 6A is a drawing showing mounting and control of the power supply unit in the case of a normal load in the third embodiment of the present invention;

FIG. 6B is a drawing showing mounting and control of the power supply unit in the case of a light load in the third embodiment of the present invention;

FIG. 7 is a diagram showing a circuit of a power supply unit in a fourth embodiment of the present invention;

FIG. 8A is a drawing showing mounting and control of the power supply unit corresponding to the circuit diagram of FIG. 7 in the case of a normal load in the fourth embodiment of the present invention;

FIG. 8B is a drawing showing mounting and control of the power supply unit corresponding to the circuit diagram of FIG. 7 in the case of a light load in the fourth embodiment of the present invention;

FIG. 9A is a drawing showing mounting and control of the power supply unit in the case of a normal load in the fifth embodiment of the present invention;

FIG. 9B is a drawing showing mounting and control of the power supply unit in the case of a light load in the fifth embodiment of the present invention;

FIG. 10 is a drawing showing the interior of a package shown in FIGS . 9A and 9B in the fifth embodiment of the present invention;

FIG. 11 is a diagram showing a circuit of a power supply unit in a sixth embodiment of the present invention;

FIG. 12 is a diagram schematically showing a configuration of a power supply unit in a conventional technology;

FIG. 13 is a diagram showing a circuit configuration of the power supply unit in the conventional technology;

FIG. 14 is a diagram for explaining the relation between the voltage drop and current of a diode;

FIG. 15 is a diagram showing a circuit configuration of a power supply unit of a synchronous rectification type in a conventional technology;

FIG. 16 is a diagram for explaining the relation between the voltage drop and current of a diode and a MOSFET; and

FIG. 17 is a diagram for explaining the relation between the output current and power supply efficiency of a power supply unit in a conventional technology.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiments, and the repetitive description thereof will be omitted.

Summary of Embodiments

A power supply unit of the present invention is made by using a semiconductor device having a high-side switching element and a low-side switching element connected in series between a voltage input terminal and a reference potential terminal connected to a DC input power supply. This semiconductor device is configured so that on and off of the high-side switching element and the low-side switching element are complementarily controlled to cause a current to flow in a choke coil connected to a connection node of the high-side switching element and the low-side switching element, thereby outputting a voltage obtained by converting a voltage applied to the voltage input terminal.

Particularly, the high-side switching element or the low-side switching element is made up of a plurality of power MOSFETs connected in parallel, and the power MOSFETs connected in parallel are controlled so that the number of the power MOSFETs in an off state is increased as the output current becomes lower. The power MOSFETs to be turned off when the output current is low are disposed on an outer side of a loop formed from a positive terminal of an input capacitor to a negative terminal of the input capacitor via the high-side power MOSFET and the low-side power MOSFET.

In the power supply unit with the configuration described above, in which the number of operating power MOSFETs connected in parallel is reduced when the output current of the power supply is reduced, in the case of a light load, the power MOSFETs disposed on an outer side of a main circuit loop formed from the positive terminal of the input capacitor to the negative terminal of the input capacitor via the high-side power MOSFET and the low-side power MOSFET are turned off, and the power MOSFETs disposed on an inner side of the loop are turned on. By this means, not only the drive loss of the power MOSFETs but also the switching loss can be reduced.

Hereinafter, embodiments based on the above-described summary of the embodiments will be described in detail.

First Embodiment

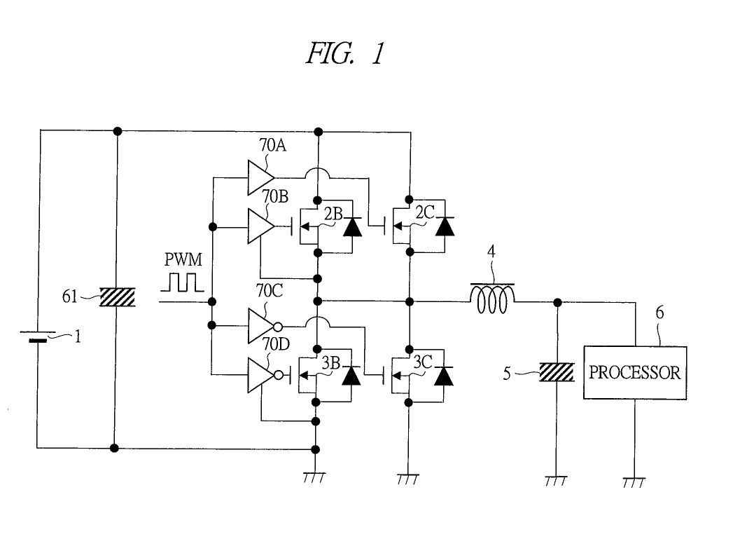

FIG. 1 is a diagram showing a circuit of a power supply unit in a first embodiment of the present invention. The power supply unit shown in FIG. 1 is formed by using a semiconductor device. The semiconductor device is made up of high-side power MOSFETs 2B and 2C, low-side power MOSFETs 3B and 3C, drive circuits 70B and 70A which drive the high-side power MOSFETs 2B and 2C, and drive circuits 70D and 70C which drive the low-side power MOSFETs 3B and 3C. The power supply unit includes a DC input power supply 1, an input capacitor 61, a choke coil 4, an output capacitor 5 and the like other than the semiconductor device. A load 6 such as a processor is connected to the power supply unit.

In FIG. 1, the two high-side power MOSFETs 2B and 2C are connected in parallel, and the two low-side power MOSFETs 3B and 3C are connected in parallel. The high-side power MOSFET 2B is driven by the drive circuit 70B, the high-side power MOSFET 2C is driven by the drive circuit 70A, the low-side power MOSFET 3C is driven by the drive circuit 70C, and the low-side power MOSFET 3B is driven by the drive circuit 70D. In the case of a light load, at least one or more gates of the power MOSFETs 2B, 2C, 3B and 3C connected in parallel are turned off, thereby suppressing the consumption of drive power.

When the gate of the power MOSFET is turned off (=the input signal of the gate is not applied), the drive loss Pdrive of the expression (3) caused by the input capacitance Ciss of the power MOSFET can be reduced.

Pdrive=Ciss×Vdrive²×fsw . . . (3)

Here, Vdrive denotes the drive voltage of the gate and fsw denotes a switching frequency.

However, even when the gates of the power MOSFETs connected in parallel are turned off, the drain terminal and the source terminal thereof are still electrically connected to a main circuit. Therefore, the switching loss caused by the output capacitance Coss between the drain and the source cannot be reduced.

When the high-side power MOSFET 2B or 2C is turned on or off, the current is steeply changed, a spike voltage in which the voltage ΔV of an expression (4) is superimposed on the input voltage from the DC input power supply 1 is generated between the drain and the source of each of the power MOSFETs 2B, 2C, 3B and 3C, and this increases the switching loss.

ΔV=Ls×di/dt . . . (4)

Here, Ls denotes parasitic inductance of a main circuit and corresponds to the inductance of the loop formed from a positive terminal of the input capacitor 61 to a negative terminal of the input capacitor 61 via the high-side power MOSFETs 2B and 2C and the low-side power MOSFETs 3B and 3C. When the parasitic inductance of the main circuit is reduced, the spike voltage can be reduced, so that the switching loss can be reduced.

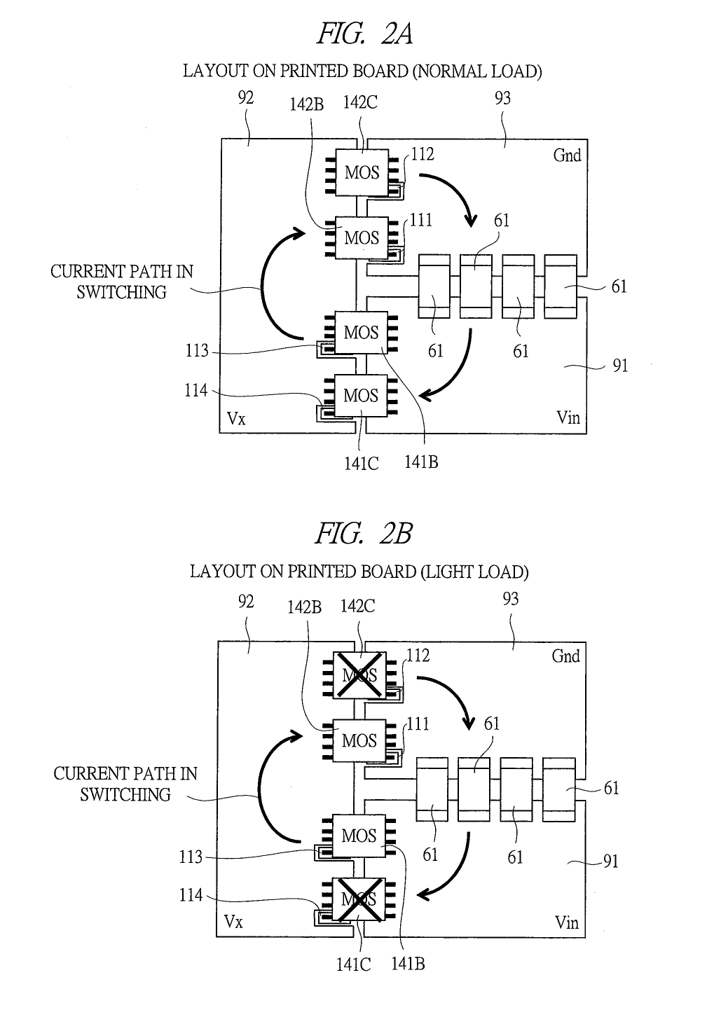

FIGS. 2A and 2B are diagrams showing mounting and control of the power supply unit corresponding to the circuit diagram of FIG. 1 in the present embodiment (FIG. 2A: the case of a normal load, FIG. 2B: the case of a light load). The power supply unit shown in FIGS. 2A and 2B is formed by mounting four input capacitors 61, two packages 141B and 141C of the high-side power MOSFETs 2B and 2C and two packages 142B and 142C of the low-side power MOSFETs 3B and 3C on a printed board.

Wiring of the printed board includes wiring (Vin) 91 connected to the positive terminal of the DC input power supply 1, wiring (Vx) 92 connected to one terminal of the choke coil 4 and wiring (Gnd) 93 connected to the negative terminal of the DC input power supply 1. The choke coil 4 is omitted in FIGS. 2A and 2B. The four input capacitors 61 are connected between Vin 91 and Gnd 93, the two packages 141B and 141C of the high-side power MOSFETs are connected in parallel, and the two packages 142B and 142C of the low-side power MOSFETs are also connected in parallel. The on/off control of the packages 141B, 141C, 142B and 142C is executed via gate terminals 111 to 114, respectively.

The arrows in FIGS. 2A and 2B represent current path in switching, and it starts from the input capacitors 61 and returns to the input capacitors 61 via the packages 141B and 141C of the high-side power MOSFETs and the packages 142B and 142C of the low-side power MOSFETs. The parasitic inductance Ls of the main circuit corresponds to the inductance of the loop shown by these arrows. Under the conditions of a normal load to a heavy load shown in FIG. 2A, all of the packages 141B, 141C, 142B and 142C connected in parallel are operated. On the other hand, under the conditions of a light load of FIG. 2B, the gate signals of the packages 141C and 142C, which are disposed on an outer side of the loop formed from the positive terminals of the input capacitors 61 to the negative terminals of the input capacitors 61 via the packages 141B and 141C of the high-side power MOSFETs and the packages 142B and 142C of the low-side power MOSFETs, are turned off, and the gate signals of the packages 141B and 142B disposed on an inner side of the loop are turned on. In this manner, by disposing the packages 141C and 142C of the power MOSFETs, which are turned off in the case of a light load, on an outer side of the main circuit loop and disposing the packages 141B and 142B of the turned-on power MOSFETs on an inner side of the main circuit loop, the parasitic inductance Ls can be reduced, so that the switching loss can be reduced.

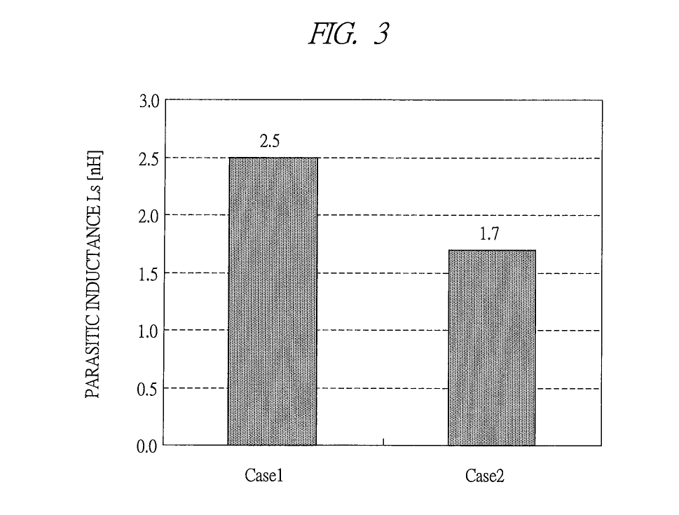

FIG. 3 is a diagram showing the effects of the present embodiment. In the Case 1, the packages 141B and 142B of the power MOSFETs on an inner side of the main circuit loop are turned off (=the packages 141C and 142C of the power MOSFETs on an outer side of the loop are on) , and the parasitic inductance Ls of the main circuit is 2.5 nH. On the other hand, in the Case 2, the packages 141C and 142C of the power MOSFETs on an outer side of the main circuit loop are turned off (=the packages 141B and 142B of the power MOSFETs on an inner side of the loop are on) , and the parasitic inductance Ls of the main circuit is 1.7 nH, which is reduced by 32% compared with Case 1.

Next, the reason why turning off the packages 141C and 142C of the power MOSFETs on an outer side of the main circuit loop in the case of a light load (=turning on the packages 141B and 142B of the power MOSFETs on an inner side of the main circuit loop) is not obvious will be described from the viewpoints of “thermal resistance” and “drive circuit”. From the viewpoint of thermal resistance, it is desirable that the packages 141B and 142B of the power MOSFETs on an inner side of the main circuit loop are turned off and the packages 141C and 142C of the power MOSFETs on an outer side of the loop are turned on. This is because, when the distance between the power MOSFETs to be heat sources is increased, the thermal resistance can be reduced and the junction temperature can be reduced. The reduction in the junction temperature has many advantages such as the reduction in on-resistance and the improvement of reliability.

Although no driver IC is illustrated in FIGS. 2A and 2B, driver ICs of the drive circuits for driving the packages 141B, 141C, 142B and 142C of the power MOSFETs are mounted on the printed board. Compared with the above-described parasitic inductance Ls of the main circuit, parasitic inductance Lg between the driver ICs and the packages 141B, 141C, 142B and 142C of the power MOSFETs has small influence on loss. However, in order to precisely control the dead time (=period in which both of the high-side power MOSFETs and the low-side power MOSFETs are turned off for preventing a through current of the high-side power MOSFETs and the low-side power MOSFETs), it is desirable that the distance between the driver ICs and the packages of the power MOSFETs is reduced and the parasitic inductance Lg between the driver ICs and the packages of the power MOSFETs is reduced. More specifically, from the viewpoint of the dead time control, it is preferable that either one of the package 141B and the package 141C close to the driver IC and either one of the package 142B and the package 142C of the power MOSFETs are driven in the case of a light load, and it cannot be said that it is always preferable to turn off the packages of the power MOSFETs on an outer side of the main circuit loop and turn on the packages of the power MOSFETs on an inner side of the loop.

As described above, the mounting and control of the power supply unit in the present embodiment are not obvious from the viewpoints of “thermal resistance” and “drive circuit”, and not only the drive loss of the power MOSFETs but also the switching loss can be reduced by turning off the packages 141C and 142C of the power

MOSFETs disposed on an outer side of the main circuit loop and turning on the packages 141B and 142B of the power MOSFETs disposed on an inner side of the loop in the case of a light load.

Second Embodiment

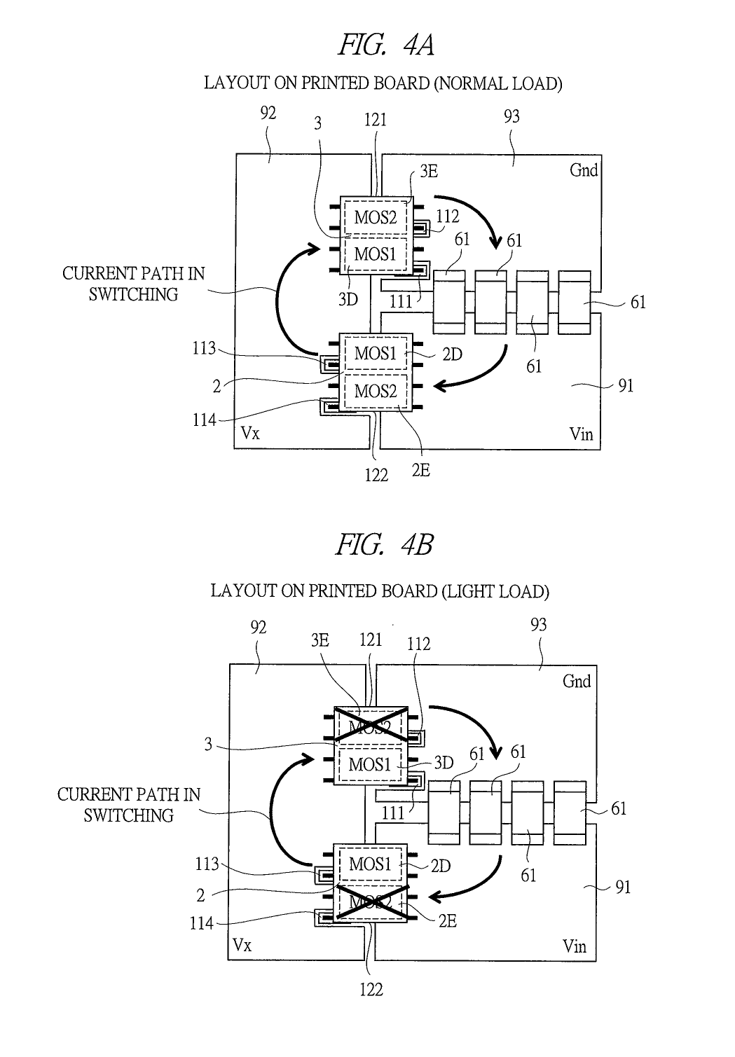

FIGS. 4A and 4B are drawings showing mounting and control of a power supply unit in a second embodiment of the present invention (FIG. 4A: the case of a normal load, FIG. 4B: the case of a light load). The present embodiment is different from the first embodiment in that high-side power MOSFETs 2D and 2E are mounted in the same package 122 and low-side power MOSFETs 3D and 3E are mounted in the same package 121. The high-side power MOSFETs 2D and 2E can be mounted on the same chip (monolithic) or can be mounted on different chips and in the same package (multi-chip). The monolithic and multi-chip can also be similarly implemented for the low-side power MOSFETs 3D and 3E. As shown in FIG. 4B, in the case of a light load, the parasitic inductance Ls of the main circuit can be reduced by turning off the gate signals of the power MOSFETs 2E and 3E disposed on an outer side of the loop, which is formed from the positive terminals of the input capacitors 61 to the negative terminals of the input capacitors 61 via the high-side power MOSFETs 2D and 2E and the low-side power MOSFETs 3D and 3E, and turning on the gate signals of the power MOSFETs 2D and 3D disposed on an inner side of the loop.

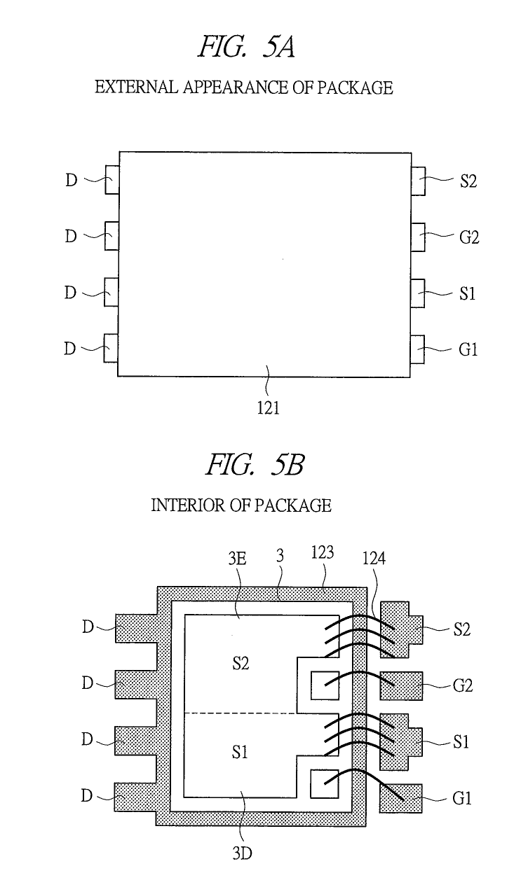

FIGS. 5A and 5B are drawings showing the details of the package 121 of the low-side power MOSFETs 3D and 3E shown in FIGS. 4A and 4B. FIG. 5A shows the external appearance of the package 121, and FIG. 5B shows the interior thereof. The same goes for the package 122 of the high-side power MOSFETs 2D and 2E. FIGS. 5A and 5B show the example in which the two power MOSFETs 3D and 3E are provided on the same chip. In FIG. 5A, four pins on the left side are drain terminals (D) , and out of four pins on the right side, G1 is a gate terminal of the power MOSFET 3D, S1 is a source terminal of the power MOSFET 3D, G2 is a gate terminal of the power MOSFET 3E, and S2 is a source terminal of the power MOSFET 3E. The power MOSFETs 3D and 3E are die-bonded to a lead frame 123, which is connected to the drain potential, and the source terminals S1 and S2 and the gate terminals G1 and G2 are connected with wires 124 by wire bonding.

Also in the mounting and control of the power supply unit in the present embodiment, by turning off the power MOSFETs 2E and 3E disposed on an outer side of the main circuit loop and turning on the power MOSFETs 2D and 3D disposed on an inner side of the loop, not only the drive loss of the power MOSFETs but also switching loss can be reduced in the case of a light load similarly to the first embodiment.

Third Embodiment

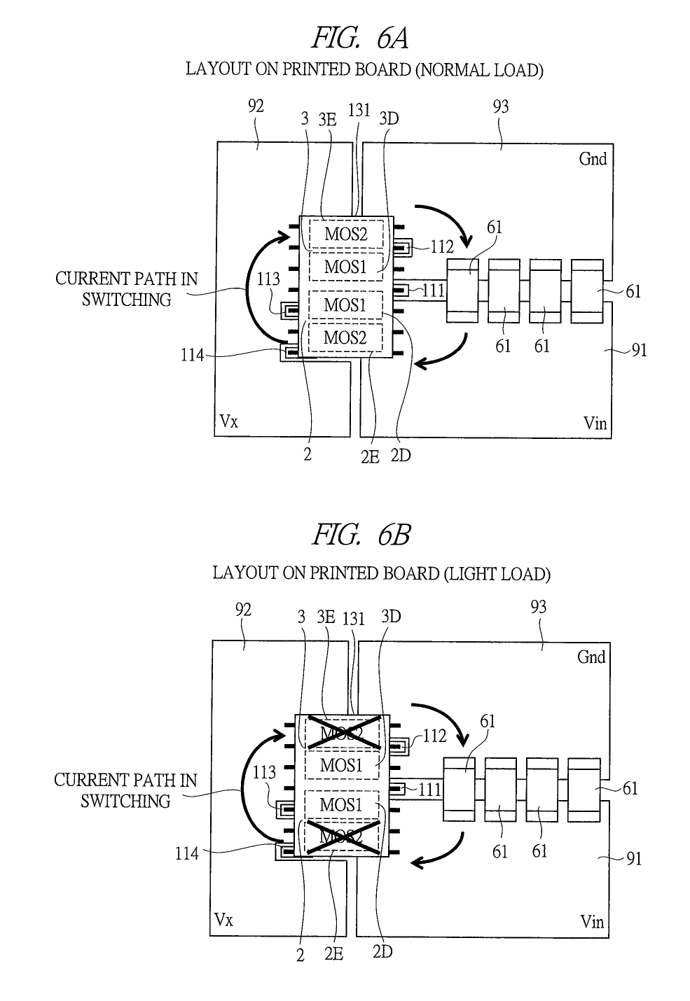

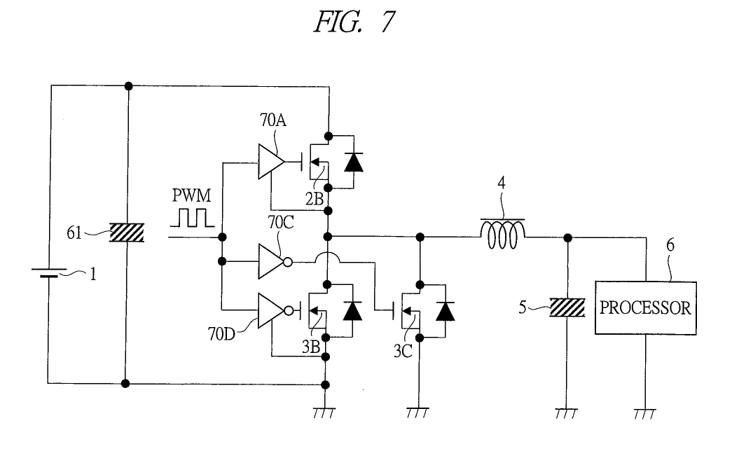

FIGS. 6A and 6B are drawings showing mounting and control of a power supply unit in a third embodiment of the present invention (FIG. 6A: the case of a normal load, FIG. 6B: the case of a light load). The present embodiment is different from the first embodiment in that a high-side power MOSFET 2 and a low-side power MOSFET 3 are mounted on the same chip 131. The high-side power MOSFET 2 is divided into two regions, that is, the power MOSFET 2D and the power MOSFET 2E. The low-side power MOSFET 3 is similarly divided into two regions, that is, the power MOSFET 3D and the power MOSFET 3E. As shown in FIG. 6B, in the case of a light load, the parasitic inductance Ls of the main circuit can be reduced by turning off the power MOSFETs 2E and 3E disposed on an outer side of the loop, which is formed from the positive terminals of the input capacitors 61 to the negative terminals of the input capacitors 61 via the high-side power MOSFETs 2D and 2E and the low-side power MOSFETs 3D and 3E, and turning on the power MOSFETs 2D and 3D disposed on an inner side of the loop.

Therefore, also in the mounting and control of the power supply unit in the present embodiment, not only the drive loss of the power MOSFETs but also switching loss can be reduced similarly to the first embodiment.

Fourth Embodiment

FIG. 7 is a drawing showing a circuit of a power supply unit in a fourth embodiment of the present invention. The present embodiment is different from the first embodiment in that there is one high-side power MOSFET (2B) and only the two low-side power MOSFETs 3B and 3C are connected in parallel. With respect to the power supply which supplies power to the load 6, for example, a processor, since the voltage of the DC input power supply 1 is 12 to 19 V and the voltage output to the load 6 is about 1 V, the duty of PWM is 10% or less. Therefore, the period in which the current flows to the high-side power MOSFET 2B within one cycle is 10% or less, and the current flows to the low-side power MOSFETs 3B and 3C in 90% or more. Therefore, the conduction loss of the low-side power MOSFETs 3B and 3C is large compared with that of the high-side power MOSFET 2B. Accordingly, the measures of increasing the number of power MOSFETs connected in parallel for reducing the conduction loss are effective in the low-side power MOSFETs.

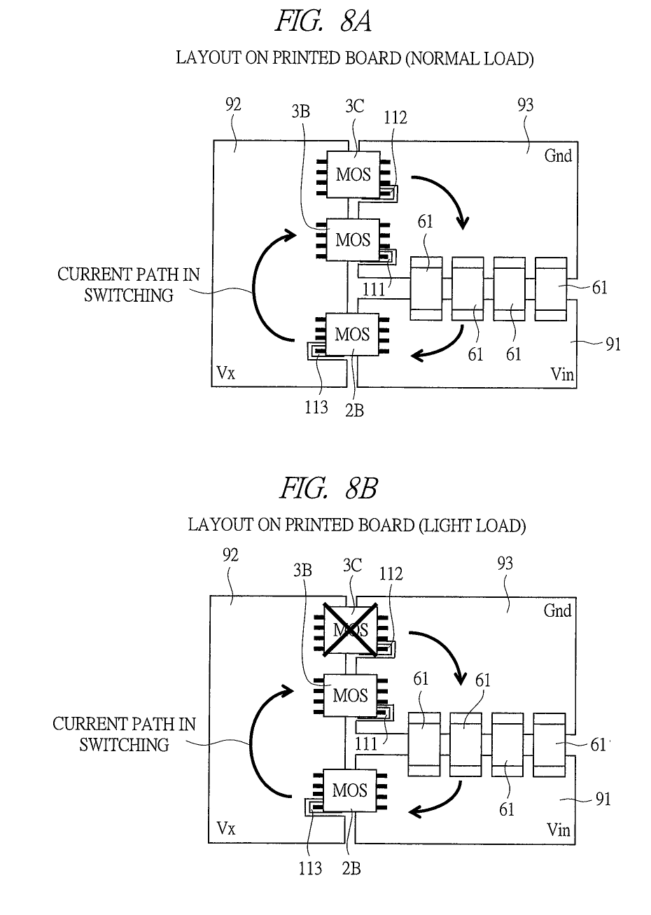

FIGS. 8A and 8B are drawings showing the mounting and control of the power supply unit corresponding to the circuit diagram of FIG. 7 in the present embodiment (FIG. 8A: the case of a normal load, FIG. 8B: the case of a light load). As shown in FIG. 8B, in the case of a light load, the parasitic inductance Ls of the main circuit can be reduced by turning off the power MOSFET 3C disposed on an outer side of the loop, which is formed from the positive terminals of the input capacitors 61 to the negative terminals of the input capacitors 61 via the high-side power MOSFET 2B and the low-side power MOSFETs 3B and 3C, and turning on the power MOSFET 3B disposed on an inner side of the loop.

Therefore, also in the mounting and control of the power supply unit of the present embodiment, not only the drive loss of the power MOSFETs but also switching loss can be reduced similarly to the first embodiment. Furthermore, the present embodiment is effective for reducing the conduction loss.

Fifth Embodiment

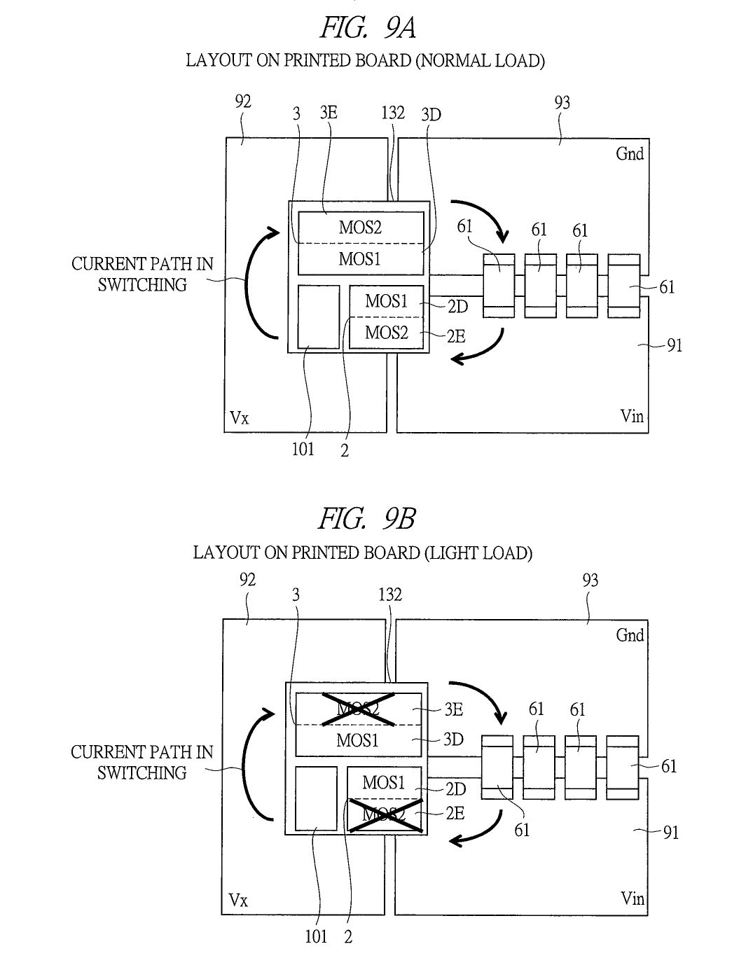

FIGS. 9A and 9B are drawings showing mounting and control of a power supply unit in a fifth embodiment of the present invention (FIG. 9A: the case of a normal load, FIG. 9B: the case of a light load). The present embodiment is different from the first embodiment in that three chips of the high-side power MOSFET 2, the low-side power MOSFET 3 and a driver IC 101 which drives them are mounted in the same package 132. As shown in FIG. 9B, in the case of a light load, the parasitic inductance Ls of the main circuit can be reduced by turning off the power MOSFETs 2E and 3E disposed on an outer side of the loop, which is formed from the positive terminals of the input capacitors 61 to the negative terminals of the input capacitors 61 via the high-side power MOSFETs 2D and 2E and the low-side power MOSFETs 3D and 3E, and turning on the power MOSFETs 2D and 3D disposed on an inner side of the loop.

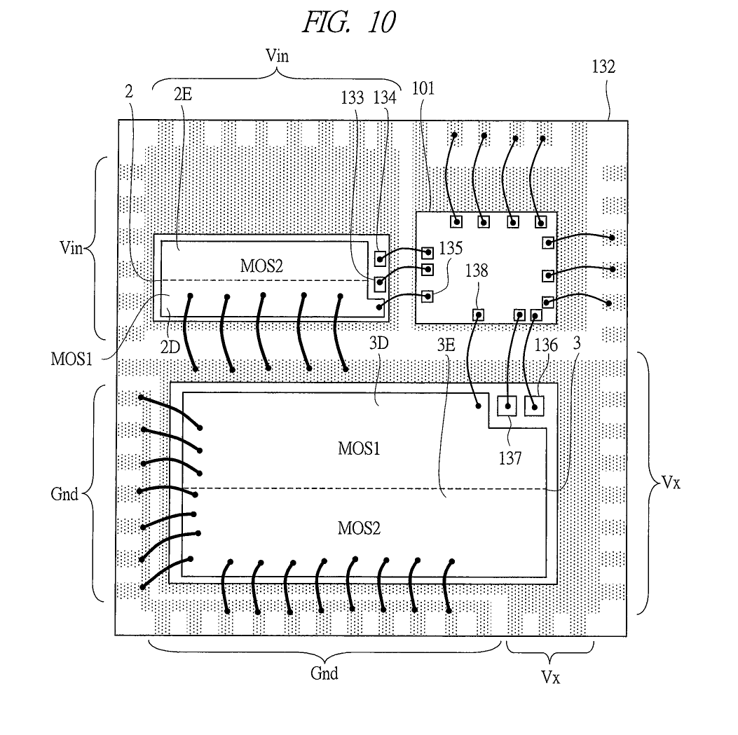

FIG. 10 is a drawing showing the interior of the package 132 shown in FIGS. 9A and 9B. In the package 132 in which the three chips of the high-side power MOSFET 2, the low-side power MOSFET 3 and the driver IC 101 which drives them are mounted, the driver IC 101 and the high-side power MOSFET 2 are mutually connected by one source terminal 135 and two gate terminals 133 and 134. The gate terminal 133 drives the high-side power MOSFET 2D, and the gate terminal 134 drives the high-side power MOSFET 2E. The driver IC 101 and the low-side power MOSFET 3 are mutually connected by one source terminal 138 and two gate terminals 136 and 137. The gate terminal 136 drives the low-side power MOSFET 3D, and the gate terminal 137 drives the low-side power MOSFET 3E. A structure such as that shown in FIG. 10 in which the three chips of the high-side power MOSFET 2, the low-side power MOSFET 3 and the driver IC 101 which drives them are mounted in the same package 132 is described in, for example, Japanese Patent Application Laid-Open Publication No. 2008-10851 (Patent Document 3).

Also in the mounting and control of the power supply unit in the present embodiment, in the case of a light load, not only the drive loss of the power MOSFETs but also switching loss can be reduced by turning off the power MOSFETs 2E and 3E disposed on an outer side of the main circuit loop and turning on the power MOSFETs 2D and 3D disposed on an inner side of the loop similarly to the first embodiment.

Sixth Embodiment

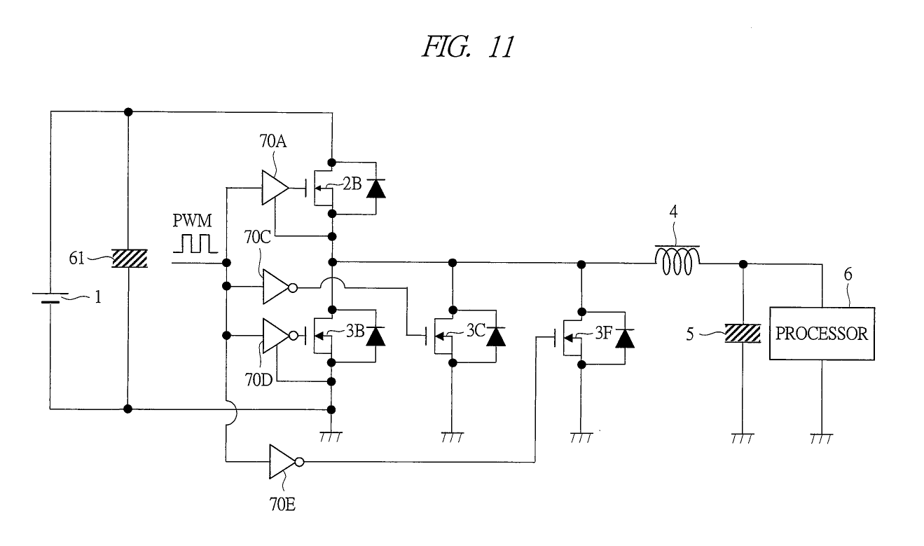

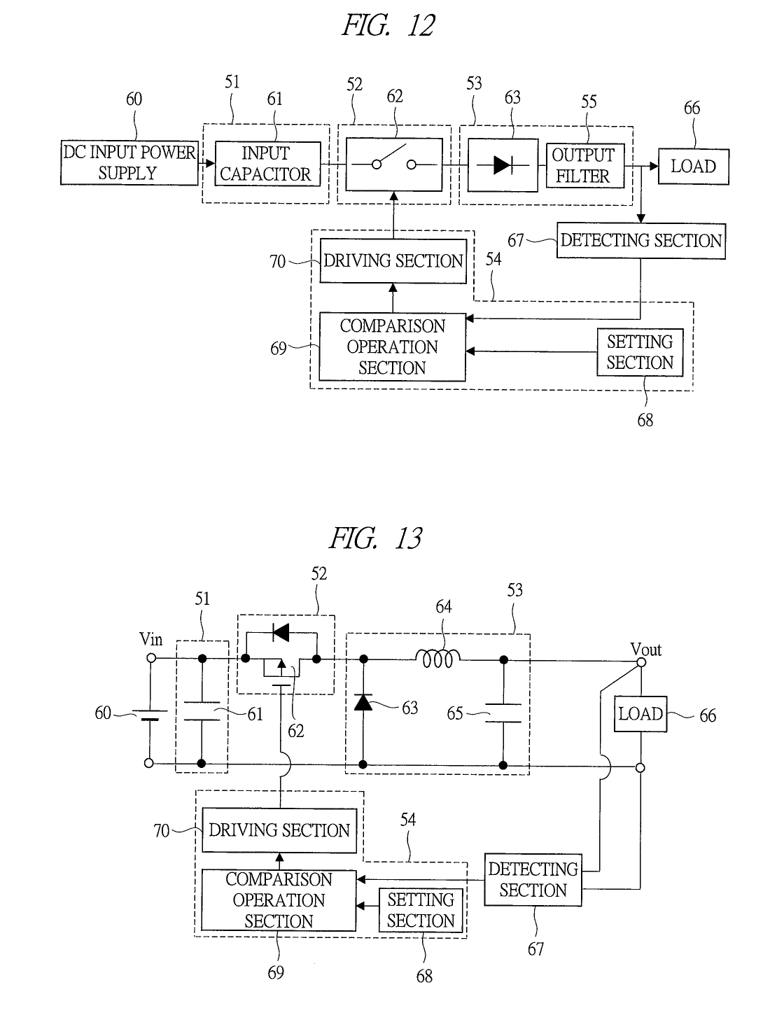

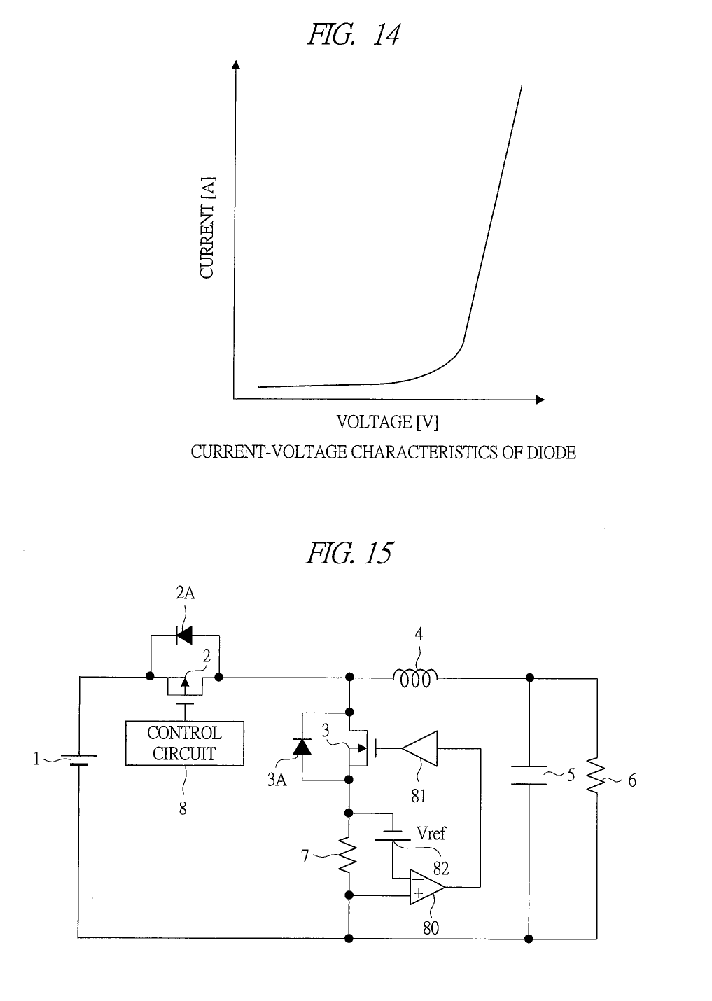

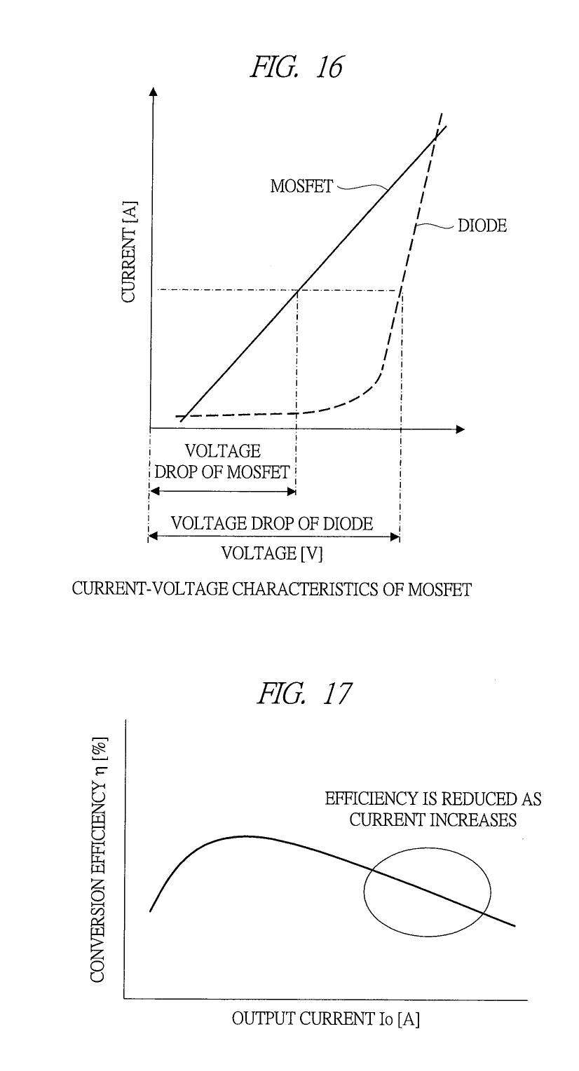

FIG. 11 is a diagram showing a circuit of a power supply unit in a sixth embodiment of the present invention. The present embodiment is different from the fourth embodiment in that the number of low-side power MOSFETs connected in parallel is increased and three power MOSFETs 3B, 3C and 3F are connected in parallel. When the number of MOSFETs connected in parallel is increased, the number of the operating power MOSFETs can be controlled in accordance with the output current in a stepwise manner by the drive circuits 70D, 70C and 70E. Therefore, high efficiency can be maintained over a wide current range from a light load to a heavy load. From a normal load to a heavy load, all of the three power MOSFETs 3B, 3C and 3F are operated, the power MOSFET 3F is turned off when the load becomes lighter, and the power MOSFET 3C is turned off in addition to the power MOSFET 3F when the load becomes further lighter. A package or a chip corresponding to the power MOSFET 3F is disposed on an outer side of the loop, which is formed from the positive terminal of the input capacitor 61 to the negative terminal of the input capacitor 61 via the high-side power MOSFET 2B and the low-side power MOSFETs 3B, 3C and 3F, a package or a chip corresponding to the power MOSFET 3C is disposed on an inner side of the package or the chip corresponding to the power MOSFET 3F, and a package or a chip corresponding to the power MOSFET 3B is disposed on a further inner side of the package or the chip corresponding to the power MOSFET 3C.

Therefore, also in the mounting and control of the power supply unit in the present embodiment, not only the drive loss of the power

MOSFETs but also the switching loss can be reduced similarly to the first embodiment. Furthermore, in the present embodiment, high efficiency can be maintained over a wide current range.

Seventh Embodiment

In the present embodiment, the areas of the power MOSFETs connected in parallel are defined. The areas of the power MOSFETs connected in parallel are not particularly mentioned in the first embodiment to the sixth embodiment, but all of the areas of the power MOSFETs connected in parallel may be the same or the areas may be different. By increasing the area ratio of the power MOSFETs connected in parallel (=reducing the area of the power MOSFET operated in the case of a light load), efficiency in the case of a light load can be improved. This is because, since the conduction loss is relatively reduced and the ratio of the drive loss is increased when the load is light, the amount of reduction in the drive loss caused by the small-area power MOSFETs exceeds the amount of increase in the conduction loss and the sum of the drive loss and conduction loss can be reduced.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be applied to a semiconductor device including a synchronous rectifier circuit used in an electronic device or others and to a power supply unit using the same.

What is claimed is:

1. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
the first or second switching element is made up of a plurality of transistors connected in parallel, and the plurality of transistors connected in parallel are controlled so that the number of the transistors in an off state is increased as an output current becomes lower, and
the transistor turned off when the output current is low is disposed on an outer side of a loop formed from a positive terminal of an input capacitor of a printed board to a negative terminal of the input capacitor via the first and second switching elements.

2. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
each of the first and second switching elements is made up of two transistors connected in parallel, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

3. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
each of the first and second switching elements is made up of two transistors connected in parallel, the two transistors constituting the first switching element are formed on two chips and mounted in the same package, the two transistors constituting the second switching element are formed on two chips and mounted in the same package, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

4. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
each of the first and second switching elements is made up of two transistors connected in parallel, the two transistors constituting the first switching element are formed on one chip, the two transistors constituting the second switching element are formed on one chip, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

5. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
each of the first and second switching elements is made up of two transistors connected in parallel, the two transistors constituting the first switching element and the two transistors constituting the second switching element are formed on one chip, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

6. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
the second switching element is made up of two transistors connected in parallel, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

7. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
each of the first and second switching elements is made up of two transistors connected in parallel, the two transistors constituting the first switching element are formed on one chip, the two transistors constituting the second switching element are formed on one chip, a driver IC for driving the first and second switching elements is formed on one chip, the first and second switching elements and the driver IC are mounted in the same package, and the two transistors connected in parallel are controlled so that one of the transistors is turned off when an output current is low, and
the transistor turned off when the output current is low is disposed on an outer side of a loop formed from a positive terminal of an input capacitor of a printed board to a negative terminal of the input capacitor via the first and second switching elements.

8. A semiconductor device comprising a first switching element and a second switching element connected in serial between a voltage input terminal and a reference potential terminal,
wherein on and off of the first and second switching elements are complementarily controlled to cause a current to flow in an inductance element connected to a connection node of the first and second switching elements, thereby outputting a voltage obtained by converting a voltage applied to the voltage input terminal,
the second switching element is made up of three transistors connected in parallel, and the three transistors connected in parallel are controlled so that one of the transistors is turned off when an output current becomes low and two of the transistors are turned off when the output current becomes further lower, and
the transistor turned off first when the output current is low is disposed on an outermost side of a loop formed from a positive terminal of an input capacitor of a printed board to a negative terminal of the input capacitor via the first and second switching elements, and the transistor turned off when the output current becomes further lower is disposed on an inner side of the loop compared with the transistor turned off first.
